(19) United States
(12) Patent Application Publication
(10) Pub. No.: US 2017/0150698 A1
(43) Pub. Date: Jun. 1, 2017

(54) MULTI-ANIMAL FEEDER DEVICE AND METHOD USING THE SAME

(71) Applicant: WISELEAP SOLUTIONS INC., Montreal, Quebec (CA)

(72) Inventors: Hamid ZAIDI, Montreal, Quebec (CA); Jamie EDELSBERG, Outremont, Quebec (CA); Ousama HRAKI, Ville Saint-Laurent, Quebec (CA); Mourad DENDANE, Terrebonne, Quebec (CA); Hugo HENRY-GARON, Laval, Quebec (CA)

(73) Assignee: WISELEAP SOLUTIONS INC., Montreal, Quebec (CA)

(21) Appl. No.: 15/323,425

(22) PCT Filed: Jul. 2, 2015
(86) PCT No.: PCT/CA2015/050620

§ 371 Date: Jan. 1, 2017

Related U.S. Application Data
(60) Provisional application No. 62/019,992, filed on Jul. 2, 2014.

(51) Int. Cl. A01K 5/02; G08C 17/02; H04B 5/00; A01K 11/00; A01K 5/01

(52) U.S. Cl. CPC A01K 5/0275; A01K 5/0225; A01K 11/006; A01K 5/0135; H04B 5/0062; G08C 17/02; G08C 2200/00

(57) ABSTRACT

A animal feeder device and method to periodically provide and/or distribute food to multiple animals based on programmable schedules. The device comprises an animal feeder comprising of at least two food bowls, typically two food storage units equipped with infrared sensors, a food dispensing system, a wireless protocol module, a GSM module, and a boosted Near Field Communications (NFC) system. The device communicates with a remote server to retrieve the instructions of food distribution and may identify the presence of one or more animal using the NFC system.

### CROSS-REFERENCE TO RELATED APPLICATIONS

The present patent application claims the benefits of priority of commonly assigned U.S. Patent Application No. 62/019,992, entitled “Internet Connected Multi-Pet Feeder with Wireless Detection and Distribution” and filed at the United States Patents and Trademarks Office on Jul. 2, 2014.

### FIELD OF THE INVENTION

The present invention relates to pet feeders, and, more particularly, to automated pet feeders, comprising remote controlling and monitoring functions, capable of measuring and dispensing food to multiple animals.

### BACKGROUND OF THE INVENTION

Nutritional needs and eating habits vary from pet to pet, thus additional commitment is needed by owners of multiple pets to meet the needs of each pet to its fullest. The task of feeding multiple pets is onerous and can become an issue at times. Issues may arise when a pet owner cannot be home for regular feeding times, has trouble keeping track of multiple animals, or is absent for an extended period of time. Many pet owners cannot take pets travelling due to travel restrictions and undue stress on the animals.

Automatic pet feeders have been known in the art and have been used by some pet owners. However, prior art automatic pet feeders available demonstrate certain functional insufficiencies, such as:
Limited remote monitoring and programming of automatic pet feeder. Options are available for remote dispensing of feed, but lack the ability to remotely program a diet and schedule. Pet owners may not be able to periodically access their phones to dispense feed at specific time intervals.
Identifying an animal typically use radio-frequency identification (RFID) between the animals and the pet feeder. As RFID technology is not compatible with most smart-devices, such as smartphones, and computer, thus limiting the technological compatibility of the animal feeder.
Identification of an animal may also uses near field communications (NFC) technologies between the animal and the pet feeder. As NFC technology has a very limited theoretical communication range of about 10 cm. However, in practice the range is closer to 4 cm. Such small communication range renders the animal detection problematic.
Automatic wireless pet feeders typically rely on wireless protocol such as Wi-Fi to connect to external devices/servers. As Wi-Fi can be temperamental, if the connection fails there is no back up connection to the external device/server.

Thus, a smart pet feeder mitigating the shortcoming of the prior art is needed.

### SUMMARY OF THE INVENTION

The aforesaid and other objectives of the present invention are realized by generally providing an internet connected multi-pet feeder with wireless detection and distribution.

One aspect of the present disclosure it to provide a feeder for multiple animals pet owners to automate the feeding of the animals with a plurality of different types of food. Food is typically material consumable by an animal or a dry solid consumable by an animal.

Another aspect of the present invention is to provide method for distribute a plurality of different types of food to multiple animals. More specifically, the method comprise periodically providing foods to animals having special eating schedules or diets, such as animal eating regular dry food and/or prescribed food. The method may further fill one or more containers with the same type of food for more capacity.

In accordance with one aspect of the invention, there is provided an animal feeder comprising of at least two fodder bowls, at least two fodder storage units equipped with infrared sensors, a fodder dispensing system, a wireless protocol module, a GSM (Global System for Mobile Communications) module, and a boosted Near Field Communications (NFC) system.

The at least two fodder bowls allow for at least two animals to feed at once and for the dispensing of at least two types of fodder; the at least two fodder storage units are capable of storing large quantity of food; the infrared sensors are capable of measuring food inventory; the fodder dispensing system and distributes the fodder from the fodder storage units into the fodder bowls; a wireless protocol module, such as a Wi-Fi module, is capable of connecting to the external server and/or external control device, such as a smart-device or a smartphone; a GSM module is capable of connecting to the external server in the event of Wi-Fi failure; the boosted near field communications (NFC) system comprises of an NFC tag and an NFC reader, where the NFC tag is attached to an animal, and the NFC reader is installed inside the animal feeder. The boosted NTC is configured to a communication range greater than the standard limit of 10 cm.

In accordance with another aspect of the invention, there is provided an animal feeder adapted to communicate with an external control device equipped with an application via an external server. The application allows for the remote monitoring and programming of the animal feeder to control each animals diet, feeding schedule, and animal feeder activity.

In accordance with another aspect of the invention, there is provided an animal feeder comprising a NFC reader configured to increase the range of communication to a distance greater than regular NFC technology. NFC technology is used to overcome the hurdle of RFID's limited compatibility. The NFC correspondence system is compatible with many smartphones, whereas RFID technology is not.

In accordance with another aspect of the invention, there is provided an animal feeder comprising a GSM technology to overcome the temperamental nature of Wi-Fi technology. The GSM module acts as a backup to connect to the external server if the Wi-Fi service fails.

In accordance with a further aspect of the invention, there is provided a multi-animal feeder comprising a casing, at least two open containers for receiving food, a food storage container, a food dispensing mechanism for controlling quantity of food to be released from the storage container to the chute, at least one passageway connecting the food dispensing mechanism to the respective open container for receiving food, controller comprising a network adapter, the controller being configured to communicate with a remote device using the network adapter and to control the dispensing mechanism based information received from the remote device. According to a further aspect of the invention, the multi-animal feeder may further comprises at least two food storage container.

In accordance with yet another aspect of the invention, a method for monitoring a multi-animal feeder comprising a controller, the controller comprising a network adapter, is provided. The method comprises establishing a communication link between the network adapter and a remote device running a program configured to communicate with the controller, communicating information relating to the status of the feeder to the remote device and receiving by the controller instructions relating to food distribution from the remote device.

In accordance with another aspect of the invention, a method of use of a multi-animal feeder as described herein is provided. The method comprises filing up the storage container with a desired volume of food, establishing a communication link between a computerized device comprising a program to communicate with the feeder and the feeder and monitoring the activity of the feeder;

In accordance with another aspect of the invention, there is provided an animal feeder comprising a housing having an upper accessible section and a lower closed section; two bowls accessible from the outside of said sections but still within said frame; a lid which covers two food hoppers which will hold the food; a first sensor mounted on said lid which detects the amount of said food in said hopper; a first visual indicator mounted on said frame which transmits the amount of said food in said hopper; a rotary mechanism in the upper section below the said hoppers to dispense said food from said hoppers to said bowls; a chute in the lower section to guide said food to said bowls; a second sensor responsive to the proximity of the animal to said feeder; a second visual indicator mounted in the lower section but visible from the outside to relay the status of said feeder; anti-slip mount located under said feeder; a control circuit board mounted in the lower section responsible for the functioning of said first sensor to detect food levels, of said second sensor to detect the animal in proximity, of said rotary mechanism to dispense food, of said first visual indicator to transmit said food level in said hopper, of said second visual indicator to relay status of the said feeder, of the communication unit to communicate via the internet or cellular network.

The above and other objects will be described in further detail in the following section accompanied with drawings.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of an automatic animal feeding device according to the principles of the present invention.

FIG. 2 is a perspective view of an automatic animal feeding device according to the principles of the present invention with the lid open revealing the two food hoppers and sensors.

FIG. 3 is an exploded view of the feeding device according to an embodiment of the present invention in accordance with the principles of the present invention.

FIG. 4 is an exploded view of the fodder distribution system in accordance with the principles of the present invention.

FIG. 5 is a side cross-sectional view of the automatic feeding device in accordance with the principles of the present invention.

FIG. 6 is a front cross-sectional view of the automatic feeding device in accordance with the principles of the present invention.

FIG. 7 is a perspective view of an embodiment of the controller of an automatic feeding device in accordance with the principles of the present invention.

### DETAILED DESCRIPTION OF THE PREFERRED EMBODIMENT

A novel animal feeder system and method will be described hereinafter. Although the invention is described in terms of specific illustrative embodiment(s), it is to be understood that the embodiment(s) described herein are by way of example only and that the scope of the invention is not intended to be limited thereby.

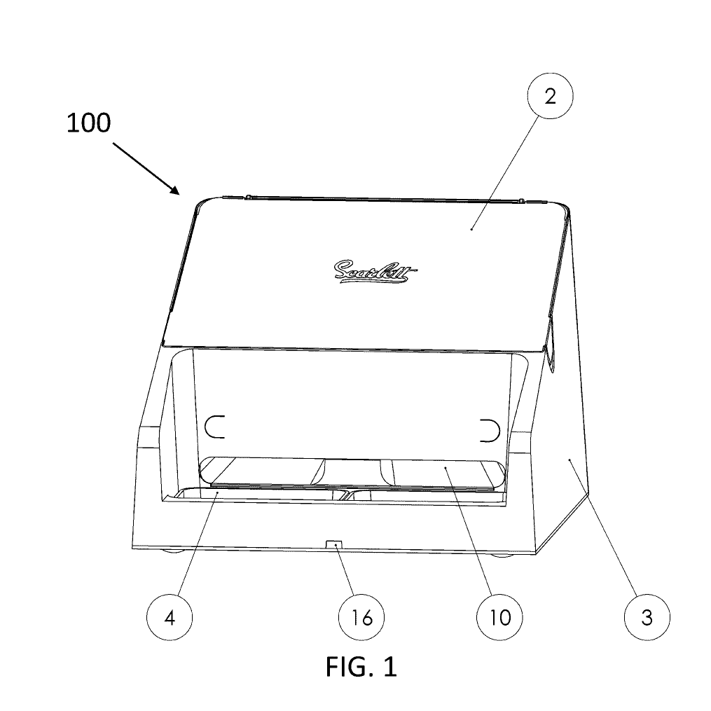

Referring first to FIGS. 1 to 4, a preferred embodiment of a connected multi-animal feeder is shown in closed and opened states. The feeder 100 comprises a main casing or housing 3, at least two open containers 4 for receiving food and allowing animal to eat the received food, such as food bowl, at least one container for storing food 6, a lid or cover 2 configured to be in a close or an open states over the storage container 6, such as fodders, at least one chute or passageway 10 connecting the container for storing food 6 to the respective open container for receiving food 4, an food dispensing mechanism for controlling quantity of food to be released from the storage container 6 to the chute 10 and a controller configured to control the dispensing mechanism based on a predetermined configuration.

In some embodiments, the housing 3 may comprise an upper portion and a lower portion. The upper portion may be opened and the lower section is closed. In a typical embodiment, the upper portion comprises the food storage containers 6 and the lower portion comprises the chute 10 and bowls 4. The upper and lower portions allow easy dissembling and assembling of the feeder 100 and/or food storage containers.

In a further embodiment, the feeder 100 may further comprise a least one food quantity indicator means, such as mechanical indicator, lights or display 23 configured to display the remaining quantity of food in the storage containers. In such an embodiment, the food quantity indicator 23 is connected to at least one food sensor 21 per storage container 6. Typically, a food sensor 21 comprises an infrared emitter and an infrared receiver installed on the pet feeder 100. The emitter sends a pulse of accurately measured infrared light and the receiver measures the intensity of the reflected light off the food. The intensity calculated is then transformed into a percentages value of the amount of remaining food inside the food hopper 6 which is communicated to the controller which is in communication with the food quantity indicator system. One skilled in the art shall understand that any other mean for measuring the quantity of remaining food in the storage containers 6 may be used. In other embodiments, the food quantity indicator may use code of different colours to indicate the level of food remaining in the food storage 6.

In yet other embodiments, the food quantity indicator may comprised of a plurality of LEDs, such as X, to indicate on a scale from 1 to X how full said hopper 6 is, one visual indicator for each said hopper 6. Typically, 5 LED shall be used for a scale of 1 to 5. The LEDs are connected to the controller.

In further embodiments, the feeder 100 may comprise on or more buttons or any user interaction systems to manually dispense food by pressing and holding said button for a predetermined period of time, such as 4 seconds. Another function of the button may be to to toggle the connectivity status of the network adapter.

In a typical embodiment, each food storage container 6 may contain up to 20 cups worth of dry food while the food sensors 21 are configured to accurately calculate the amount of food remaining in each hopper separately in increments of 5%. Understandably, under configurations allowing different quantity of food and different increment calculation may be used.

In other embodiments, the feeder may comprise an indicator of the status of the connectivity 25 of the feeder with a network. In some embodiment, the connectivity indicator may be a LED light 25 behind a diffuser 16 which flashes in a predetermined fashion which attracts the attention of the pet when it is time to feed.

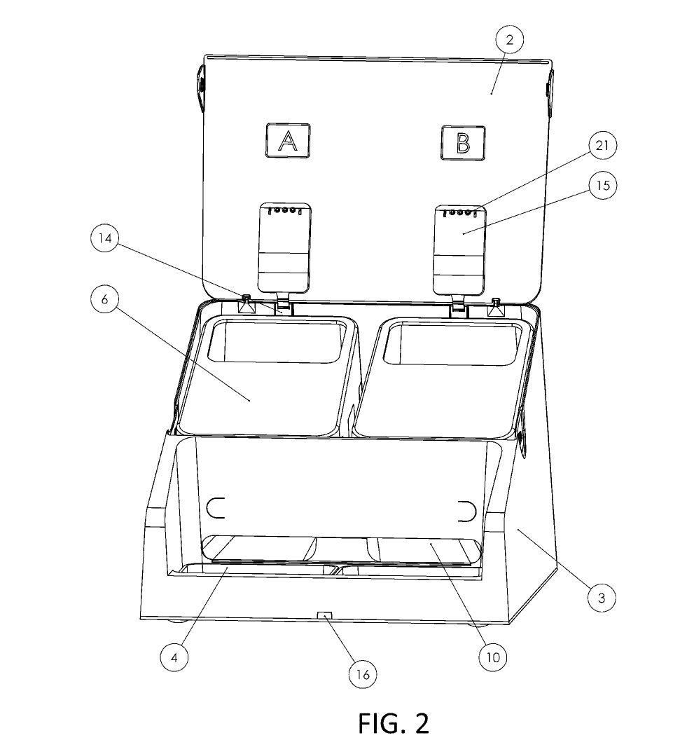

Now referring to FIG. 2, an embodiment of the apparatus having the lid in an open state is shown. In such a state, one may refill the storage container with food or gain access to the interior of the feeder 100 casing 3.

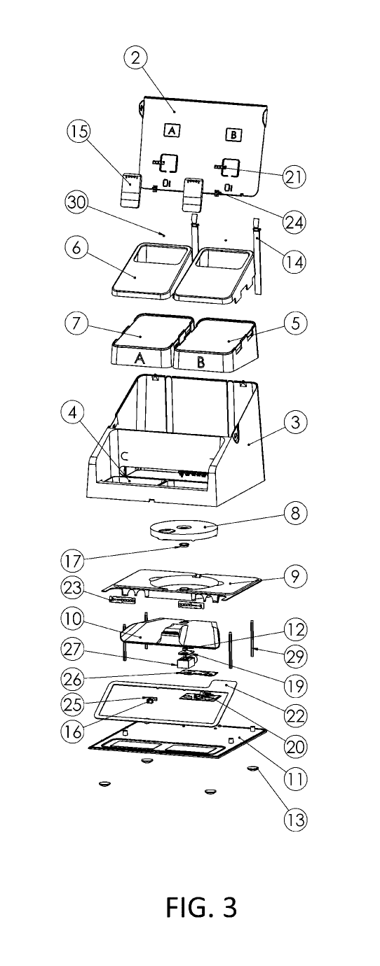

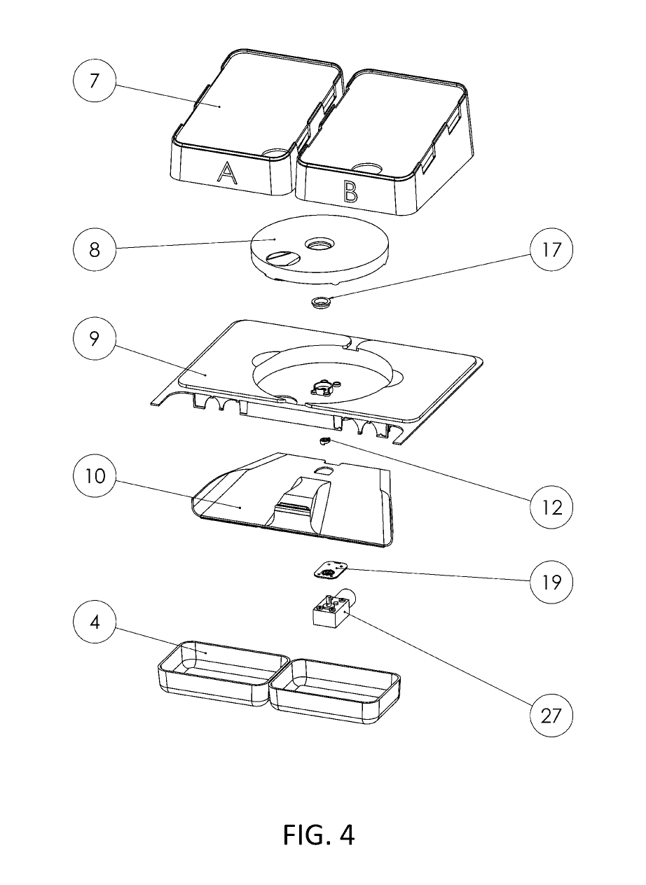

Now referring to FIG. 3, an exploded view of the embodiment of a feeder i shown. The components hidden by the casing or housing 3 are shown. In such an embodiment, the feeder 100 further comprises an intermediate floor 9 on which the storage containers 6 rest. The intermediate floor 9 houses the food dispensing mechanism which is described in further details bellows (see FIG. 4). In such an embodiment, the food chute 10 is fixed to the under surface of the intermediate floor 9. In an embodiment where the food dispensing unit comprises a motor 27, the motor is also attached on the under surface of the intermediate floor 9. The intermediate floor 9 is attached to the casing to remain in place. In a preferred embodiment, a plurality of standoffs 29 are fixed or screwed 31 into the bottom of the housing 3 or on a bottom cover 11.

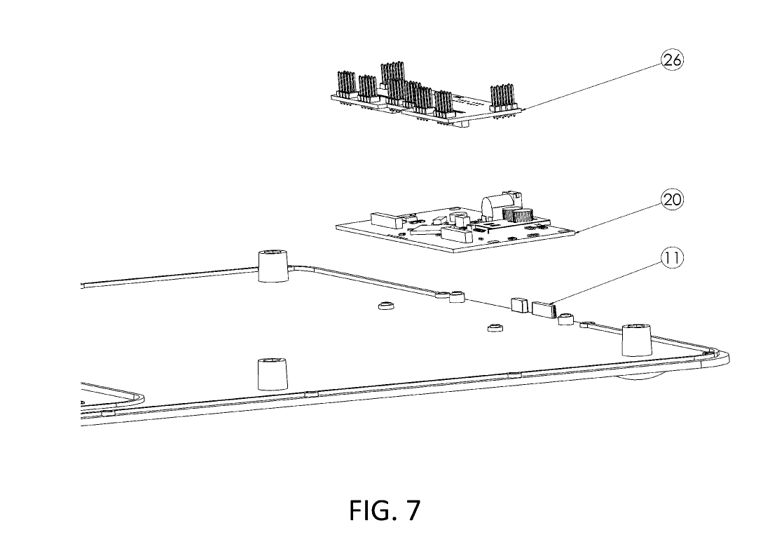

Now referring to FIG. 7, in a preferred embodiment, the controller typically comprises a main board 20, an I/O board 26 and may comprise a memory for storing information such as configuration settings and/or diets. The main board 20 generally comprises a network communication controller or adapter, such as a wireless network communication adapter, a power source and a central processing unit (CPU). The main board 20 may further comprises a second network communication adapter such as a GSM or mobile communication controller or adapter or an adapter connected to another network to act as a backup connection in the event of the failure of the network communication adapter. The network adapter is configured to communicate with a server. The main board is typically fixed on the casing 3 or to a bottom cover 11.

The network communication adapter, such as a wireless network adapter communicates over a network, such as the Internet, a WAN, a LAN or any other types of networks, with a device or a server to send updates to the owner and allow to remotely control the feeder with a computerized device such as a computer, a tablet or a smartphone.

Obviously, in embodiment using a wireless adapter, the adapter is to be configured to connect to the network. The steps to configure the wireless adapter are as follows, press and hold both buttons located on said first visual indicator for predetermined period of time, such as 5 seconds. When said second visual indicator changes color to show said feeder is allowing outsides access, said owner connects to the feeder and configures it.

The I/O board 26 comprises a plurality of pins or connectors in which the various electrical components of the feeder 100 connects to. The I/O board may be customized to be suitable for a plurality of configurations as far as electrical components are concerned. The I/O board is typically inserted in the main board 20 and is near the various sensors and indicators.

In a preferred embodiment, the controller is configured to communicate with a server or remote device to retrieve information such as configuration, food diet plans or any other relevant information. The controller may receive instructions from the server to execute an action, such as supply food or to stop supplying food. The controller may also communicate information to the server such as, but not limited to, the status of the feeder 10, the remaining quantity of food in the storage container 6, the presence of one or more animal within a predetermined range of the feeder.

Still referring to FIG. 3, the feeder 100 comprises communications system to detect the presence of one or more animal within a predetermined range of the feeder 100. Such comprises an identification tag located on each animal interacting with the feeder 100 and an identification reader allowing the detection of the identification tag within the range. In a preferred embodiment, the communication system is embodied as a boosted near field communications (NFC) system comprising one or more NFC tag and an NFC reader, each NFC tag being attached to an animal and the NFC reader is within the casing 3 of the feeder 100. The boosted NFC system is configured to a communication within a range greater than the standard limit of 10 cm. The NFC reader comprises a wireless antenna 22, such as an NFC antenna or RF antenna, configured to detect one or more animals within a predetermined radius of the feeder 100. Typically, the antenna 22 is located closed to the food bowls 4 to improve the detection of an animal in proximity.

Typically, the animal feeder 100 is configured to communicate with an external control device running a program or application in communication with a server or with the controller of the feeder 100. The program or application allows the remote monitoring and programming of the animal feeder to control each animal diet, feeding schedule, and animal feeder activity. The server may be remote or within a local area network.

The feeder may further comprise a sensor for detecting if the lid 2 is in a closed or opened state. Such sensor is typically embodied as a Hall Effect sensor which detects a magnet 30 placed inside one or more hoppers 6.

In another embodiment, a plurality of anti-slip means 13, such as anti-slip pads, may be attached underneath the casing 3 or a bottom cover to prevent the feeder 100 from being moved by an animal. In some embodiments, the anti slip means are four dome shaped pads made from a rubber like material to prevent the feeder 100 to be displaced or moved by said animal when feeding and otherwise.

In FIG. 4, an exploded view of a preferred embodiment of the food dispenser system is shown. The lower portion of the food storage container 7 is shown and illustrates how the food is funnelled to an aperture of the storage container 7. Typically, the storage container 7 comprises an angled bottom to allow food to be funnelled in the aperture.

As described above, the food dispensing system is typically housed in the intermediate floor 9. The food dispensing system comprises a dispenser disk 8 comprising an aperture and a cavity configured to contain a predetermined volume of food, such a ⅛ of a cup of food, an mean for producing rotation 27 to the disk 8 such as a motor 27, a positioning mean 12 keeping track of the mean for producing rotation 27, such as block or any other mechanism for positioning and a positioning unit, such as a positioning circuit board.

The food dispensing system is connected to the controller to communicate information about the rotation of the food dispensing system. In other embodiment, a different control unit could be used in association with the main controller. The controller is further configured to cause the food dispensing system to: (a) rotate said disk clockwise or counter clockwise until the positioning controller indicates that the disk is aligned with the food storage container and pause for predetermined time period, such as 1 second (b) rotate the dispensing disk in the opposite direction until said positioning board indicates that the disk is aligned with the chute 10 which will guide the food to the bowls 4 and pause for a predetermined period of time, such as 2 seconds (c) repeat (a) and (b) until the required amount of food is distributed to the bowl 4.

The controller typically monitors the position of said disk continuously. If after executing steps (a), (b) and (c), the controller doesn't receive an indication that the disk has reached the desired position, the controller is configured to rotate back and forth until desired position is reached.

The dispenser disk 8 is housed in a cavity of the intermediate floor 9 having a shape compatible with the dispenser disk 8 and which allow the rotation of the dispenser disk 8 with respect to the intermediate floor 9 on a substantially vertical axis.

A bushing 17, such as nylon or rubber bushing may be inserted between the disk 8 and the intermediate floor 9. To contain a predetermined volume of food, the disk 8 typically comprises a cavity having the predetermined volume. As the dispensing disk 8 turns within the cavity of the intermediate floor 9, food held in the disk 8 is released into the food chute 10 and slides in the food bowl 4.

The motor 27 typically comprises a shaft and is connected to a power source and to a positioning controller 19, such as a PCB or to the main controller. The position of the positioning block 12 is captured by the positioning controller and communicated to the central controller.

In a preferred embodiment, the positioning block 12 is made of a resistant material, such as metal and is centered with regard to the shaft of the motor 27. In an embodiment comprising a positioning or motor controller 19, the positioning block 12 in installed on the positioning controller 19 which sits on the motor 27. Rotation of the positioning block 12 is driven by the shaft of the motor 27. When a desired position of the disk 8 is reached, the positioning block 12 opens a contact on the motor controller 19 which send a message or signal to the motor 27 to stop the rotation or the spinning. Understandably, one skilled in the art shall understand that other ways of implementing the stopping of the motor may be used.

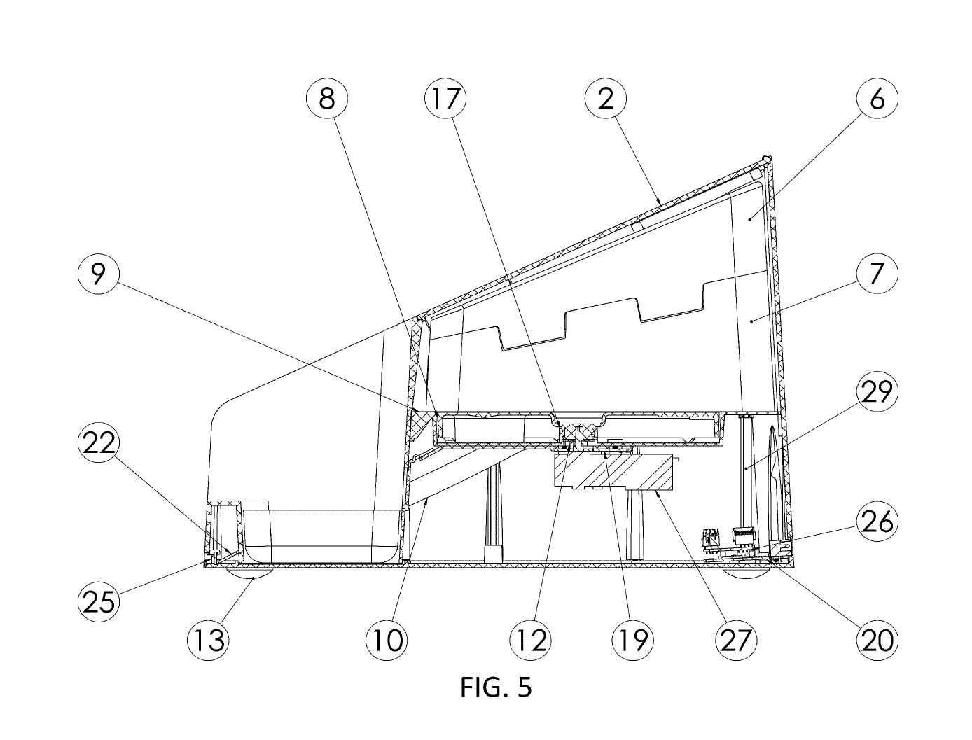

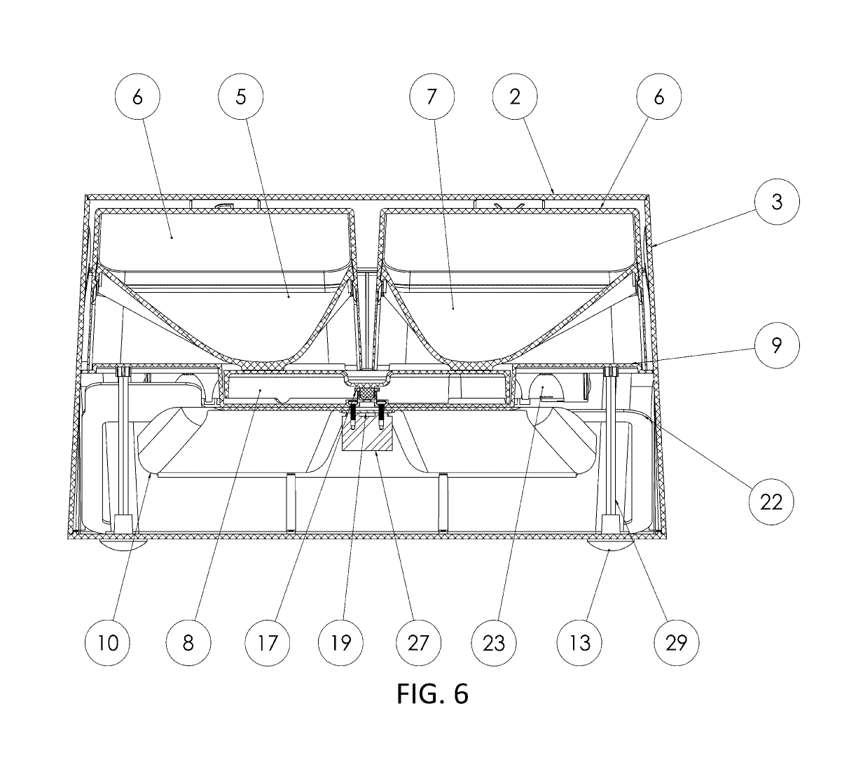

Now referring to FIG. 5 and FIG. 6, a cross section view of the side and rear of the apparatus is shown. While the feeder 100 is in standby, the aperture to the food bowls 7 as well as the aperture of the dispensing disk 8 are sealed using any sealing mean, such as folding door. Such sealing means ensures that the animal does not extract or eat more food or fodder than the predetermined volume set by the user and to prevent outside contaminants to enter.

In another embodiment, the feeder 100 may further comprise an independent power source, such as a battery, to allow the feeder to be powered in the event of power outages. Such independent power source component may be installed on the bottom cover 11 or on the bottom of the casing 3 and may comprise an access panel to be able to replace the independent power source component on a need to basis.

The feeder may be used by an animal owner to ensure continuous food supply to multiple animals. The owner must fill up the storage container 6 with a desired volume of food. The owner must use a device in communication with the feeder 100, either directly through a network using any communication protocol or indirectly through a server or remote device in communication with the feeder 100. The device may be used to monitor the activity of the feeder 100, the remaining quantity of food and/or the presence of the animals within a predetermined range of the feeder 100. The device may also be configured to send command to the feeder 100 such as distributing more food in the food bowls 4 or stopping the distribution of food. The device may also program or change the scheduling of the food distribution for a specified period.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A multi-animal feeder comprising:
a casing;
at least two open containers for receiving food;
a food storage container;
a food dispensing mechanism for controlling quantity of food to be released from the storage container to the chute;
at least one passageway connecting the food dispensing mechanism to the respective open container for receiving food;
controller comprising a network adapter, the controller being configured:
to communicate with a remote device using the network adapter;
to control the dispensing mechanism based information received from the remote device.

2) The multi-animal feeder of claim 1, wherein the feeder further comprises at least two food storage container.

3) The multi-animal feeder of claim 1, wherein the feeder further comprises at least one food storage container per open container for receiving food.

4) The multi-animal feeder of any of claims 1 to 3, wherein the feeder further comprises a communications system to detect the presence of one or more animal within a predetermined range of the feeder, the communication system comprising one or more identification tag located on each animal interacting with the feeder and an identification reader allowing the detection of the identification tag within the predetermined range.

5) The multi-animal feeder of claim 4, the communications system being a boosted near field communications (NFC) system, the identification tag being an NFC tag and the identification reader being a NFC reader, wherein the boosted NFC system is configured to a communication within a range greater than standard NFC system.

6) The multi-animal feeder of any of claim 4 or 5, wherein the feeder further comprises an antenna close to the at least two open containers to improve the detection of an animal in the predetermined range.

7) The multi-animal feeder of any of claims 4 to 5, wherein the feeder further system for automatically measuring the quantity of remaining food in the storage.

8) The multi-animal feeder of any of claims 1 to 3, wherein the feeder further system for automatically measuring the quantity of remaining food in the storage.

9) The multi-animal feeder of claim 8, wherein the system for automatically measuring the quantity of remaining food in the storage comprises a food sensor per food storage container.

10) The multi-animal feeder of claim 9, the food sensor comprising an emitter and the feeder comprising a receiver, wherein the emitter is configured to send a signal in the food storage container and wherein the receiver measures the intensity of the reflected signal off the food to measure the volume of remaining food.

11) The multi-animal feeder of claim 10, the emitter being an infrared emitter, the receiver being a infrared receiver and the signal being a pulse of infrared light emitter.

12) The multi-animal feeder of any of claims 7 to 11, the feeder further comprising an indicator of the food quantity remaining based on value retrieved from the system for automatically measuring the quantity of remaining food in the storage.

13) The multi-animal feeder of any of claims 1 to 3, the feeder further comprising an indicator of the food quantity remaining in the food storage container.

14) The multi-animal feeder of any of claims 1 to 11, wherein the feeder further comprises a cover configured to be in a close state or in an open state over the food storage container.

15) The multi-animal feeder of claim 14, the feeder further comprising a sensor for detecting the open or close state of the cover.

16) The multi-animal feeder of claim 15, the cover sensor being a Hall Effect sensor and the food storage container comprising a magnet in range of the cover sensor.

17) The multi-animal feeder of any of claims 1 to 16, the food dispensing system comprising:
a dispenser disk;
a motor;
a positioning mechanism keeping track of the motor rotation;
a positioning controller connected to the controller, the positioning controller being configured to:
capture the position of the dispenser disk;
communicate the captured position to the central controller.

18) The multi-animal feeder of claim 17, the dispensing disk comprising a cavity configured to hold a predetermined volume of food and an aperture for receiving food.

19) The multi-animal feeder of any of claim 17 or 18, the feeder comprising an intermediate floor in between the food storage container and the passageway, wherein the food dispensing unit is housed in the intermediate floor.

20) The multi-animal feeder of any of claims 17 to 19, the controller is further configured to:
control the rotation of the dispensing disk in a direction until the positioning controller indicates that the disk is aligned with the food storage container and pause for predetermined time period;
control the rotation of the dispensing disk in the opposite direction until said positioning controller indicates that the disk is aligned with the passageway and pause for a predetermined period of time;
control the rotation in any direction until the required quantity of food is distributed to the at least two open containers.

21) The multi-animal feeder of any of claims 17 to 20, the motor comprising a shaft and the positioning block being centered with regard to the shaft.

22) The multi-animal feeder of any of claims 1 to 21, the controller is further configured to communicate with a remote device to retrieve food distribution schedules.

23) The multi-animal feeder of any of claims 1 to 22, the network adapter being a wireless network adapter.

24) The multi-animal feeder of any of claims 1 to 23, the controller further comprising a second network adapter configured to communicate in the event of failure of the first network adapter.

25) The multi-animal feeder of claim 24, the second network adapter being a GSM adapter.

26) A method for monitoring a multi-animal feeder comprising a controller, the controller comprising a network adapter, the method comprising:
establishing a communication link between the network adapter and a remote device running a program configured to communicate with the controller;
communicating information relating to the status of the feeder to the remote device;
receiving by the controller instructions relating to food distribution from the remote device.

27) A method for monitoring a multi-animal feeder as claimed in claim 26, the method further comprising receiving by the controller food distribution schedules and animal information from the remote device.

28) A method for monitoring a multi-animal feeder as claimed in any of claim 26 or 27, the communicated information relating to the status comprise the level of food in a food storage.

29) A method for monitoring a multi-animal feeder as claimed in any of claims 26 to 28, wherein the network adapter is a wireless adapter.

30) A method of use of a multi-animal feeder a claimed in claim 1, the method comprising:
filing up the storage container with a desired volume of food;
establishing a communication link between a computerized device comprising a program configured to communicate with the feeder and the feeder using the network adapter;
monitoring the activity of the feeder using the communication link.

31) A method of use of a multi-animal feeder a claimed in claim 30, the method further comprising monitoring the remaining quantity of food in the food storage container.

32) A method of use of a multi-animal feeder a claimed in any of claim 30 or 31, the method further comprising monitoring the presence of the animals within a predetermined range of the feeder.

33) A method of use of a multi-animal feeder a claimed in any of claims 30 to 32, the method further comprising sending command to the feeder from the computerized device.

34) A method of use of a multi-animal feeder a claimed in any of claims 30 to 33, the method further comprising changing the scheduling of the food distribution for a specified period.
